(19) United States
(12) Patent Application Publication
(10) Pub. No.: US 2014/0227404 A1
(43) Pub. Date: Aug. 14, 2014

(54) DENTAL BONE MAKING PROCESS

(71) Applicant: Vital Source Group LLC, New York, NY (US)

(72) Inventor: Hong-Li Gao, Nanjing (CN)

(73) Assignee: VITAL SOURCE GROUP LLC, New York, NY (US)

(21) Appl. No.: 14/220,541

(22) Filed: Mar. 20, 2014

Related U.S. Application Data
(63) Continuation of application No. 13/764,789, filed on Feb. 12, 2013, now abandoned.

(51) Int. Cl. A23K 1/00; A23K 1/10

(52) U.S. Cl. CPC A23K 1/003; A23K 1/106; A23K 1/103
USPC 426/233; 426/645; 426/245; 426/643; 426/646; 426/240

(57) ABSTRACT

This invention pertains to dental bones made from one, or several of, fresh or dried: beef skin, pork skin, lamb skin, poultry skin, rabbit skin, or fish skin as raw material; washing said raw material; turning said raw materials into skin paste; turning said skin paste into gelatin; adding additional ingredients to said gelatin; mixing said additional ingredients in said gelatin; cooling said mixed gelatin; cutting said mixed gelatin; drying said cut gelatin; and injecting said dried cut gelatin into a mold. The finished product has a longer expiration date, tastes better, and is healthier for pets.

### BACKGROUND OF INVENTION

1. Field of the Invention

This invention pertains to making dental bones for pets; more specifically; it involves a process for making dental bones for pets and the product made by this process.

2. Description of Related Art

There are more and more families raising pets in modern society, many pet owners consider their pets a member of their family. Other than pet food, snacks are the most purchased pet product. Snacks are used for training, supplementing pets' nutrition, and cleaning their teeth. Most dogs favor snacks they can chew on, especially snacks they can chew on that are granulated or injected into bone shapes.

In recent years, bone shaped pet treats have become very popular; there are two basic techniques for producing these pet snacks. The first method involves making these products by cleaning pork or beef skin, deoiling and drying the skin, then cutting it into the desired shape by hand or machine. The advantages of this kind of production are that it achieves the desired appearance and the cost of equipment is low. However, when labor costs are high, this labor intensive production technique becomes expensive. Moreover, human processing increases waste and defective products, thereby further increasing production costs.

A second method for making bone shaped treats involves injecting granulated materials into a mold. This type of product primarily uses powdered cereal starches as their base material; these starches are mixed with water and granulated into shapes using a granulating machine. A side effect of using so much starch is that the starch allows for the growth of worms and bad bacteria like salmonella if moistened, thereby shortening the time the product can remain on the shelf. Without moisture the treat can't be flexible; a moisture content of 23% or higher is needed to make the treat flexible.

Pet cats and dogs usually prefer the chewy granulated injected snacks. In the past, these products have been highly rigid because of high starch and low water content, which in turn makes them crumbly and less durable. Because the granulated injected snacks are so brittle and crumbly they break down into hard pieces which are difficult for the pet to digest.

### SUMMARY

This invention describes a process for making dental bone treats for pets and the product made by that process. This invention comprises the use of one or more of the following products as initial ingredients: one or more of either fresh or dried beef skin, pork skin, lamb skin, poultry skin, rabbit skin, or fish skin, bone powder, minced meat, glycerin, and natural spices. The following steps of an embodiment of the process comprise specific steps; each such step need not be performed, or performed in the specific order written. The steps taken, and in what order they are taken determine the end product: soaking the beef skin, pork skin, poultry skin, rabbit skin, or fish skin particles in water; mixing fresh beef skin, pork skin, poultry skin, rabbit skin, or fish skin in the meat grinder and making it into 1-1.2 inch sized particles; running the material through the bone paste machine to make skin paste; mixing the materials in the kneading machine at a high temperature to form gelatin; adding meat bone powder, animal albumin powder, and glycerin; continue to knead until well mixed; taking the mixture out of the kneading machine; drying; cutting into small pieces; granulating; drying; then using injection machine to form the final product.

The final product should appear to be the original color of the meat and bone material used for materials. The color may be adjusted by adding chlorophyll, spirulina, etc. or color additives to adjust the product to the desired color. The final product is rich in nutrition; tastes like skin, meat and bones; functions well for improving appetite; cleans teeth and improves dental health; contains no starch; has little moisture; and is easy to digest.

### OBJECTS AND ADVANTAGES

The present disclosure can provide a number of objects and advantages depending on the particular aspect, embodiment, and/or configuration. None of the particular objects and advantages that follow must be entirely satisfied as they are non-exclusive alternatives and at least one of the following objects and advantages is met; accordingly, several objects and advantages of the present invention are:
(a) to provide a means for making a dental bone using one or more of either fresh or dried beef skin, pork skin, poultry skin, rabbit skin, and fresh fish skin; combined with meat bone powder produced from fresh meat bones which have been steamed or cooked and de-oiled; all of which are cheap to purchase, widely available, and do little harm to the environment;
(b) to provide a means for making a dental bone made from animal skin which is easy for pets to digest, and which comprises the use of meat bone powder as a source of protein and minerals;
(c) to provide a means for making a dental bone comprising the use of a heated gelatin that is easier to form into specific shapes;
(d) to provide a means for making a dental bone with low moisture, high flexibility, consistent quality and longer expiration times on the shelves;
(e) to provide a means for making a dental bone using a high pressure injection mold, giving the bones a tough texture and durability, providing for frequent use by the pet, improving nutrition and the removal of plaque and tartar;
(f) to provide a means for making a granulated injection dental bone without using starch from vegetable matter, making it easy for pets to digest and absorb;
(g) to provide a means for making a granulated injection dental bone from skin gelatin, meat bone powder, and natural spices, which has a flavor preferable to pets;
(h) to provide a means for making a dental bone characterized by high protein content compatible with animal collagen, low fat, low carbohydrates and abundant nutrients;
(i) to provide a mean for making a completely natural dental bone without food additives (preservatives, antioxidants, foaming agents, color fixatives, etc.);
(j) to provide a means for making a dental bone using Cobalt 60 irradiation;
   these and other objectives and advantages of the instant invention will become apparent from the following description taken in conjunction with the accompanying examples and certain embodiments of the instant invention.

### DETAILED DESCRIPTION OF A PREFERRED EMBODIMENT

For the purposes of promoting an understanding of the principles of the present invention, reference will now be made to specific embodiments; however, the illustrated embodiments are merely exemplary and many additional embodiments of this invention are possible. It is understood that no limitation of the scope of the invention is thereby intended. Any alterations and further modifications of the illustrated embodiments, and such further application of the principles of the invention as illustrated herein are contemplated as would normally occur to one skilled in the art to which the invention relates

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Embodiments of the present invention comprise a process for making dental bones for pets and a product made by that process. The dental bones the process makes combine the health advantages of using materials derived from meat and bone as opposed to vegetable starch as well as reducing the overall labor required to make dental bones. The following steps of an embodiment of the process comprise specific steps; each such step need not be performed, or performed in the specific order written. The steps taken, and in what order they are taken determine the end product:

A. Choosing raw materials: take food grade raw materials from one or more of either fresh or dried beef skin, pork skin, lamb skin, poultry skin, rabbit skin, or fish skin.

B. Wash Raw Materials: wash said raw materials of foreign matters.

C. Crushing raw materials: optionally, crush raw materials into little particles that are 3 mm-10 mm in diameter, or use a meat grinder to grind the raw materials into particles that can be sifted through 1-1.2 inch sized sifters.

D. Soaking raw materials: optionally, soak raw materials in water with roughly a 2:1 to 1:2 ratio of raw material to water for roughly ten hours.

E. Making skin paste: place raw materials into bone paste machine and make skin paste.

F. High-temperature kneading: optionally, run around 0.10-0.15 MPa steam through a kneading machine's sleeve; then put skin paste in the kneading machine until the mixture is cured into a gelatin, which may take around 30 minutes.

G. Adding ingredients: optionally, add bone powder made from one or more of: beef, lamb, pork, chicken, duck, rabbit, or etc.; glycerin; and/or natural spices to the kneading machine. The bone powder used may be made from fresh bone that is deoiled in a high temperature and pressure steamer or cooker. The bone powder may be applied as a cool dry spray. You may also add some nutritional additives such as: glucosamine, chondroitinsuldate, chlorophyll, spirulina, yeast powder, malt extract, or etc. These additives may influence the color of the end product.

H. Kneading: continue kneading until the skin paste and added ingredients are well mixed into the kneaded materials, which may take around 20 minutes.

I. Cooling: take the kneaded material from the kneading machine and spread it on a cooling sheet and let cool, preferably at room temperature for roughly 2 hours.

J. Cutting into pieces: optionally, after cooling, use a cutting machine to cut the kneaded materials into strings or chunks roughly 3-5 cm long.

K. Extruding: optionally, take the cut strings or chunks and put them into an extruder, or granulator; extruding them into skinny, long strings roughly 5 mm diameter.

L. Second Cooling: optionally, allow the extruded materials to cool.

M. Second Cutting: optionally, place the extruded material into the cutting machine again to cut into little particles of material with a diameter of roughly 5 mm.

N. Drying: optionally, put the particles of material into an oven tunnel or oven room and roast them until the moisture in the particles is reduced to around 20% or less. An oven room or oven tunnel or roughly 60 degrees Celsius can be used for about 5 hours.

O. Injecting into a mold: put the dried particles of material into an injection molding machine using high pressure and temperature to mold the particles of material into bone shapes or whatever shape is desired.

P. Third cooling: optionally, allow the molded materials to cool to room temperature.

Q. Packaging: optionally, vacuum seal the molded materials in plastic sheets.

R. Irradiation: optionally, apply irradiation to the molded materials. Such application of irradiation may comprises CO-60 radiation disinfecting, with a radiation measurement of 7 to 8 kilograys of radiation.

X. Detect metal: detect presence of metal in product.

The steps for making dental bones outlined above create a product that is completely natural and, after irradiation, has a longer expiration time on a shelf without the use of starch or food additives such as: preservatives, anti-oxidants, foaming agent, color fixatives, etc.; which can create unknown chemical reactions in the product. Additionally, the dental bone treats do not use vegetable protein or starch; making it more difficult worms and salmonella to grow while providing more nutrition and making it easier for your pet to digest.

The end product of this process is a dental bone characterized by high protein compatible to animal collagen, low fat, low carbohydrates, and low moisture; with a chewy more durable texture than typical starch based injection mold dental bones. This durable structure allows the dental bones made by the process of this invention capable of sustaining more chewing before breaking into pieces. Additionally, the high pressure used during the injection molding step makes the dental bone even more durable. Persistent use of the product can remove tarter, promote dental health, and improve nutrition. The use of higher temperatures allows the gelatin to be more flexible, making it easier to shape into the desired for.

Dental bones made by this process are more flavorful than starch based dental bones because of their mixture of skin gelatin, bone powder, and meat grinds; additionally, it's been cured to bring out the flavor of the skin, meat, and bone. The addition of meat bone powder creates a great source of protein and minerals for the pets; while curing the skin mixture into gelatin makes it easier for pets to absorb.

### EXAMPLES

### Example 1

Take 5 Kg of clean and dried beef skin particles from a food turnover barrel, add 10 Kg of clean water, mixed well and let stand for roughly 10 hours. Take the skin particles that are under water and place them in a bone paste machine. Run the bone paste machine until the skin turns into a skin paste. While running 0.15 MPa of steam through the sleeve of a kneading machine sleeve, dump skin paste into the kneading machine and knead for 30 minutes until the mixture is cured into gelatin. Add 1 Kg of bone powder and 300 g of glycerin; continue kneading in the kneading machine for another 30 minutes until completely mixed. Take the material out and place on a sifter plate, cool in room temperature, and use a cutting machine to cut the material into 5 cm square pieces. Put the 5 cm square pieces into an extruding machine and make strings with a diameter of 5 mm. Cool the strings in room temperature, then using the cutting machine again, cut the strings into 5 mm square particles. Roast the particles in a drying tunnel until their moisture level is around 20%. Put the roasted particles into an injection mold machine with a mold shaped like bones and make dental bones. Cool to roughly 20-25 degree Celsius and package.

### Example 2

Take 10 Kg fresh fish skin from a food turnover barrel, run it through a grinding machine until it passes through 1 inch sifters. Add 5 Kg of water to the raw materials, mix well, and let sit for 10 hours. Put the skin particles which are below the water into a bone paste machine and run until it becomes skin paste. While running 0.10 MPa of steam through the sleeve of a kneading machine sleeve, dump skin paste into the kneading machine and knead for 30 minutes until the mixture is cured into gelatin. Add 1 Kg of chicken bone powder, 300 g of glycerin, and 20 g of spirulina 20 g to the gelatin; continue kneading in the kneading machine for another 30 minutes until completely mixed. Take out the material and place on the sifter plate, cool in room temperature, and use a cutting machine to cut the material into 5 cm square pieces. Put the 5 cm square pieces into an extruding, or granulating, machine and make strings with a diameter of 5 mm. Cool the strings in room temperature, then using a cutting machine, cut the strings into 5 mm square particles. Roast the particles in a drying tunnel until their moisture level is around 20%. Put the roasted particles into an injection mold machine with a mold shaped like a fish and make a dental bone shaped like a fish. Cool to roughly 20-25 degree Celsius and package.

It is to be understood that while certain forms of the invention are illustrated, it is not to be limited to the specific forms or arrangements herein described or shown. It will be apparent to those skilled in the art that various changes may be made without departing from the scope of the invention and the invention is not to be considered limited to what is shown and described in the specification.

### CONCLUSION

One skilled in the art will readily appreciate that the present invention is well adapted to carry out the objectives and obtain the ends and advantage mentioned, as well as those inherent therein. The embodiments, methods, procedures, and techniques described herein are presently representative of the preferred embodiments; are intended to be exemplary; and are not intended as limitations on the scope. Changes therein and other uses will occur to those skilled in the art which are encompassed within the spirit of the invention and are defined by the scope of the claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the claims.

1. A dental bone made by the process comprising:
choosing one, or several of, fresh or dried: beef skin, pork skin, lamb skin, poultry skin, rabbit skin, or fish skin as raw material;
washing said raw material;
turning said raw materials into skin paste;
turning said skin paste into gelatin;
adding additional ingredients to said gelatin;
mixing said additional ingredients in said gelatin;
cooling said mixed gelatin;
cutting said mixed gelatin;
drying said cut gelatin;
injecting said dried cut gelatin into a mold.

2. The dental bone made by the process of claim 1, further comprising crushing said washed raw materials prior to turning said raw materials into skin paste.

3. The dental bone made by the process of claim 1, wherein said crushed materials are crushed into particles that are 3 mm-10 mm in diameter, or grinder with a meat grinder into particles that can be sifted through 1-1.2 inch sized sifters.

4. The dental bone made by the process of claim 1, further comprising soaking the washed raw materials for one or more hours prior to turning said raw material into skin paste.

5. The dental bone made by the process of claim 1, wherein the skin paste is turned into gelatin using a kneading machine, wherein 0.10-0.15 MPa of steam is run through a sleeve in the kneading machine.

6. The dental bone made by the process of claim 1, wherein the additional ingredients comprise bone powder made from one or more of: beef, lamb, pork, chicken, duck, or rabbit;
glycerin; and natural spices.

7. The dental bone made by the process of claim 1, wherein said bone powder is acquired from fresh bone that was steamed or cooked under high temperature and pressure to rid the bone of oil, cooled, and then sprayed onto the gelatin dry.

8. The dental bone made by the process of claim 1, wherein the additional ingredients comprise one or more of: glucosamine, chondroitinsuldate, chlorophyll, spirulina, yeast powder, or malt extract.

9. The dental bone made by the process of claim 1, wherein cutting the gelatin further comprises:
cutting the gelatin into chunks roughly 3-5 cm long;
extruding or granulating said chunks into strings with a diameter of roughly 5 mm.

10. The dental bone made by the process of claim 9, further comprising:
cooling said strings;
cutting said strings into particles with a diameter of roughly 5 mm.

11. The dental bone made by the process of claim 1, wherein drying the gelatin further comprises putting said cut materials in an oven tunnel or oven room and roasting them until the moisture in the particles is reduced to around 20% or less.

12. The dental bone made by the process of claim 1, wherein drying the gelatin further comprises putting said cut materials in an oven tunnel or oven room with a temperature of roughly 60 degrees Celsius for about 5 hours.

13. The dental bone made by the process of claim 1, wherein injecting said dried cut gelatin into a mold further comprises using a high temperature and pressure injection mold.

14. The dental bone made by the process of claim 1, wherein injecting said dried cut gelatin into a mold further comprises using a bone or fish shaped mold to create bone or fish shaped dental bones.

15. The dental bone made by the process of claim 1, further comprising letting said injection molded material cool to room temperature and vacuum sealing said injection molded material in plastic sheets.

16. The dental bone made by the process of claim 1, made without any vegetable proteins, starch, or food additives.

17. The dental bone made by the process of claim 1, wherein no food additives, including:
preservatives, antioxidants, bleach, blowing or foaming agents, or color retention agents are added.

18. The dental bone made by the process of claim 1, further comprising irradiation.

19. The dental bone made by the process of claim 1, wherein the irradiation comprises CO-60 radiation disinfecting, with a radiation measurement of 7 to 8 kilograys of radiation.

20. The dental bone made by the process of claim 1, further comprising detecting metal content.
